(19) United States
(12) Patent Application Publication
(10) Pub. No.: US 2009/0085498 A1
(43) Pub. Date: Apr. 2, 2009

(54) Electron emission device for back light unit and liquid crystal display thereof

(76) Inventor: Chul-Ho Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/219,032

(22) Filed: Jul. 15, 2008

(30) Foreign Application Priority Data
Aug. 8, 2007 (KR) 10-2007-0079525

(51) Int. Cl. H05B 41/36

(52) U.S. Cl. 315/294

(57) ABSTRACT

The electron emission display device includes a light source unit having a plurality of gate electrodes and a plurality of cathode electrodes, the light source unit configured to emit electrons in accordance with voltages of the gate electrode and the cathode electrode, and to direct the emitted electrons to an anode electrode, a gate driver configured to transmit a driving waveform to the gate electrodes, and a cathode driver configured to transmit a driving waveform to the cathode electrodes, wherein at least one driving waveform transmitted by the gate driver and the cathode driver is a non-impulse waveform.

### BACKGROUND OF THE INVENTION

1. Field of the Invention

Embodiments relate to an electron emission device for a back light unit and a liquid crystal display thereof. More particularly, embodiments relate to an electron emission device capable of reducing distortion of a driving waveform to easily represent grey levels, and a liquid crystal display thereof.

2. Description of Related Art

A flat panel display includes a plurality of pixels arranged on a substrate in a matrix. Scan lines and data lines are coupled with each of the plurality of pixels to selectively apply a data signal to the pixels to display an image.

These flat panel displays have been used as display devices for portable information terminals, such as personal computers, mobile phones, PDA, and the like, or monitors of various information appliances. For example, a liquid crystal display (LCD) using a liquid crystal panel, an organic light emitting display using an organic light emitting diode (OLED), a plasma display using a plasma display panel (PDP), and an electron emission display (EED) using an electron emission device are widely known. An electron emission display may be used as a backlight unit of a LCD.

In order to control an amount of electrons released due to an image signal, the EED generally uses pulse width modulation of an impulse waveform to control luminance. When a pulse width increases, a period during which electrons are released increases, resulting in high luminance. When a pulse width decreases, a period during which electrons are released decreases, resulting in low luminance.

However, signal distortion is caused due to the presence of a resistor component and a capacitor component in a light source unit of the electron emission display device. If the resistor component and/or the capacitor component are large, then signal distortion is large. When signal distortion is large, representation of desired grey levels may not be possible by adjusting the pulse width.

Also, regions that are the nearest to and furthest from a driver transmitting a driving waveform vary. Accordingly, since a distortion level in a pulse width of a driving waveform transmitted to the same lines is varied. Accordingly, a luminance of the light emitted from the light source unit may vary across regions.

### SUMMARY OF THE INVENTION

Embodiments are therefore directed to an electron emission display device for use as a backlight unit, an LCD using the same and associated methods, which substantially overcome one or more of the disadvantages of the related art.

It is therefore a feature of an embodiment to provide an electron emission display device capable of representing grey levels by using a driving waveform having a slope sufficient to reduce distortion of a driving waveform, an LCD thereof, and associated methods.

At least one of the above and other features and embodiments may be realized by providing an electron emission display device, including a light source unit including a plurality of gate electrodes and a plurality of cathode electrodes, the light source unit configured to emit electrons in accordance with voltages of the gate electrode and the cathode electrode, and to direct the emitted electrons to an anode electrode, a gate driver configured to transmit a driving waveform to the gate electrodes, and a cathode driver configured to transmit a driving waveform to the cathode electrodes, wherein at least one driving waveform transmitted by the gate driver and the cathode driver is a non-impulse waveform.

The at least one driving waveform may be one of a trapezoidal waveform, a triangular waveform, and a semi-sinusoidal waveform.

The at least one driving waveform may include substantially equal rising and falling times. The rising and falling times together may account for at least half of a pulse width of the at least one driving waveform or an entirety of the pulse width of the at least one driving waveform. The rising and falling times may each account for between about one quarter to about one half of a pulse width of the at least one driving waveform.

At least one of the above and other features and embodiments may be realized by providing a liquid crystal display, including a pixel unit including a plurality of liquid crystal cells, the pixel unit being configured to display an image by transmitting or blocking light selectively in accordance with a data signal and a scan signal, a data driver transmitting the data signal to the pixel unit, a scan driver transmitting the scan signal to the pixel unit, and a back light unit transmitting light to the pixel unit, the backlight unit including a light source unit having a plurality of gate electrodes and a plurality of cathode electrodes, the light source unit configured to emit electrons in accordance with voltages of the gate electrode and the cathode electrode, and to direct the emitted electrons to an anode electrode, a gate driver configured to transmit a driving waveform to the gate electrodes, and a cathode driver configured to transmit a driving waveform to the cathode electrodes, wherein at least one driving waveform transmitted by the gate driver and the cathode driver is a non-impulse waveform.

The at least one driving waveform may be one of a trapezoidal waveform, a triangular waveform, and a semi-sinusoidal waveform.

The at least one driving waveform may include substantially equal rising and falling times. The rising and falling times together may account for at least half of a pulse width of the at least one driving waveform or an entirety of the pulse width of the at least one driving waveform. The rising and falling times may each account for between about one quarter to about one half of a pulse width of the at least one driving waveform.

At least one of the above and other features and embodiments may be realized by providing a method of operating an electron emission display device including a light source unit having a plurality of gate electrodes and a plurality of cathode electrodes, the method including transmitting a gate driving waveform to the gate electrodes; and transmitting a cathode driving waveform to the cathode electrodes, wherein at least one driving waveform of the gate driving waveform and the cathode driving waveform is a non-impulse waveform, and electrons are emitted in accordance with voltages of the gate electrodes, the cathode electrodes and an anode electrode.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1A to FIG. 1F illustrate driving waveforms transmitted to an electron emission display device according to an embodiment;

FIG. 2 illustrates a schematic view of the electron emission display device according to an embodiment; and

FIG. 3 illustrates a schematic view of a liquid crystal display according an embodiment.

### DETAILED DESCRIPTION OF THE INVENTION

Korean Patent Application No. 10-2007-0079525, filed on Aug. 8, 2007, in the Korean Intellectual Property Office, and entitled: “Electron Emission Device for Back Light Unit and Liquid Crystal Display Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

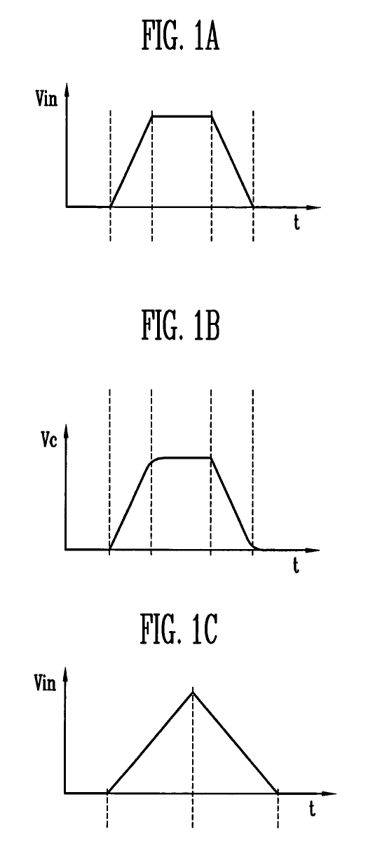

FIG. 1A to FIG. 1F illustrates driving waveforms transmitted to an electron emission display device according to an embodiment.

FIG. 1A illustrates a trapezoidal driving waveform, and FIG. 1B illustrates a driving waveform that is charged/discharged in/from an electrode when driven by the trapezoidal driving waveform. FIG. 1C illustrates a triangular driving waveform, and FIG. 1D illustrates a driving waveform that is charged/discharged in/from an electrode when driven by the triangular driving waveform. FIG. 1E illustrates a semi-sinusoidal driving waveform, and FIG. 1F illustrates a driving waveform that is charged/discharged in/from an electrode when driven by the semi-sinusoidal driving waveform.

Referring to FIG. 1A to FIG. 1F, a distortion phenomenon of the waveform is closed related to a rising time or a falling time of the waveforms. The shorter the rising time or the falling time, the larger the distortion phenomenon of the waveform. Particularly, when an input waveform is an impulse waveform, e.g., a square wave, the rising time and the falling time are very short. According to Equation 1 and Equation 2 on the basis of this relation, a delay of the waveform is very serious if the rising time and the falling time are very short, as is the case for an impulse waveform.

$$Vic ( t ) = Vin * ( 1 - {e}^{\frac{- t}{RC}} ) \qquad Equation 1$$

In Equation 1, V (ic) represents a voltage charged in a capacitor, and Vin represents a voltage input to the capacitor.

$$Voc ( t ) = {Vin}^{*} ( 1 - {e}^{\frac{- t}{RC}} ) \qquad Equation 2$$

In Equation 2, V (oc) represents a voltage discharged from the capacitor, and Vin represents a voltage input to the capacitor.

According to the above-mentioned Equation 1 and Equation 2, if the resistor component and/or the capacitor component are large, distortion of a signal is large. When the distortion of a signal is large, representation of desired grey levels by adjusting a pulse width may be impossible.

However, if the input waveform is a non-impulse waveform, e.g., any one of a trapezoidal waveform, a triangular waveform and a semi-sinusoidal waveform, as shown in FIG. 1A, FIG. 1C and FIG. 1E, then the rising time and falling time may be sufficiently long to prevent distortion. For example, the rising time and falling time of a waveform may each be greater than about one-quarter of the overall pulse width, as shown in FIG. 1A, or may each be about one-half of the pulse width, as shown in FIGS. 1C and 1E.

Therefore, a delay of the waveform does not appear in the waveforms shown FIG. 1B, FIG. 1D and FIG. 1F. Accordingly, driving waveforms transmitted to electrodes that are the closest to and furthest from a driver have a low waveform difference, i.e., are substantially the same. Thus, a difference in luminance does not occur, since distortion of the waveform by a resistor component and a capacitor component formed on the electrode does not arise.

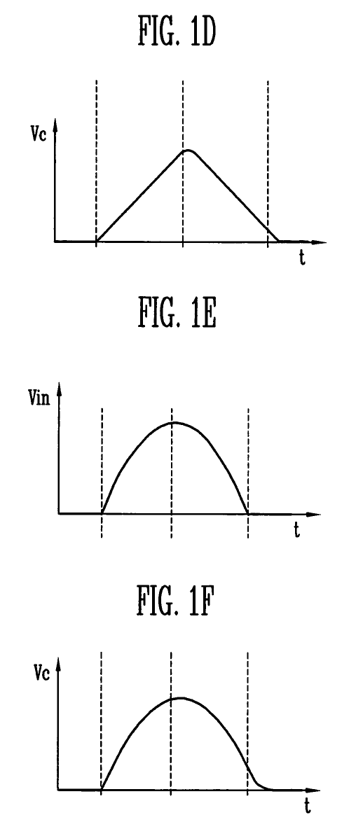

FIG. 2 illustrates a schematic view of an electron emission display device according to an embodiment. Referring to FIG. 2, the electron emission display device may include a light source unit 10a, a cathode driver 20a, and a gate driver 30a.

The light source unit 10a may include a plurality of light sources 11a formed where gate electrodes (G1,G2 . . . G1) cross cathode electrodes (C1,C2 . . . Ck). Electrons emitted from the cathode electrodes (C1,C2 . . . Ck) collide with the anode electrode to allow a phosphor to emit light. The light emitting intensity may be determined according to the amount of the electrons emitted from the cathode electrodes (C1,C2 . . . Ck), and to correspond to a grey level value of the image signal.

The cathode driver 20a may be coupled to the cathode electrodes (C1,C2 . . . Ck), and may generate a cathode signal to be transmitted to the light source unit 10a. The gate driver 30a may be coupled to the gate electrodes (G1,G2 . . . G1), and may generate a gate signal to be transmitted to the light source unit 10a. The circuit cost and power consumption may be reduced in a mode of displaying the entire image by allowing the light source unit 10a to sequentially emit the light for a certain period in a line scan mode by horizontal line. A cathode signal and a gate signal output from the cathode driver 20a and/or the gate driver 30a respectively, may be a non-impulse waveform, e.g., any one of a trapezoidal waveform, a triangular waveform, and a semi-sinusoidal waveform, as shown in FIG. 1A to FIG. 1F.

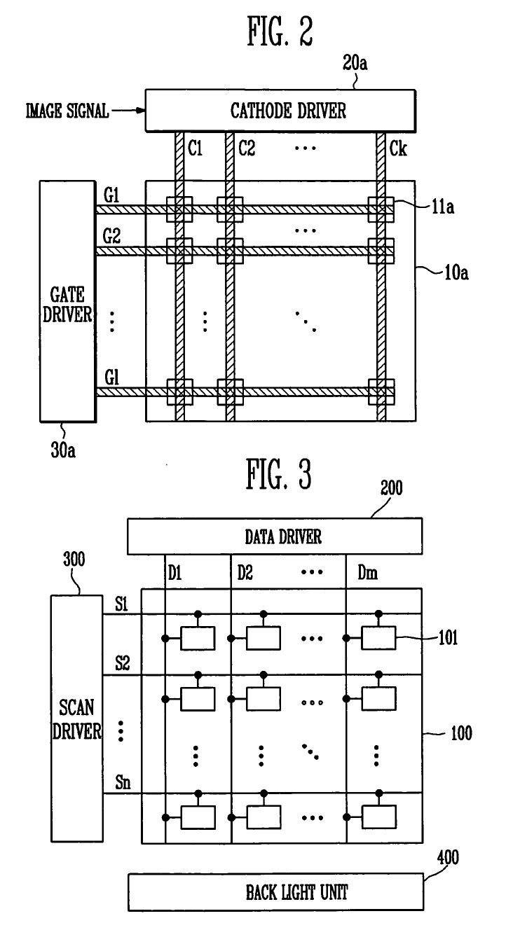

FIG. 3 illustrates a schematic view of a LCD according to an embodiment. Referring to FIG. 3, the LCD may include a pixel unit 100, a data driver 200, a scan driver 300, and a back light unit 400.

The pixel unit 100 may include a plurality of pixels 101 where a plurality of scan lines (S1,S2, . . . Sn) cross a plurality of data lines (D1,D2 . . . Dm). One pixel may correspond to one liquid crystal cell. Each liquid crystal cell may receive a data signal and a scan signal through the data lines (D1,D2 . . . Dm) and the scan lines (S1,S2, . . . Sn), and liquid crystal alignment of the liquid crystal cell may be adjusted to control the transmission or blocking of light, to thereby display an image. The pixel unit 100 may be divided into a plurality of blocks, and may receive a separate light source by blocks to display an image. Blocks that display a bright image may receive light from a bright light source, and blocks that display a dim image may receive light from a dim light source. Therefore, the pixel unit 100 may adjust a dim region and a bright region to respective brightness in one screen.

The data driver 200 may be coupled to a plurality of data lines (D1,D2 . . . Dm), may transmit a data signal to a plurality of the data lines (D1,D2 . . . Dm) and may allow the plurality of the data lines (D1,D2 . . . Dm) to transmit the data signal to pixels 101. The scan driver 200 may be coupled to the plurality of scan lines (S1,S2, . . . Sn), may transmit a scan signal to the plurality of the scan lines (S1,S2, . . . Sn) and may allow the plurality of the scan lines (S1,S2, . . . Sn) to transmit a data signal to the pixels 101 selected by the scan signal.

The backlight unit 400 may generate light and may transmit the generated light to the pixel unit 100. The backlight unit 400 may be configured with an electron emission display including a plurality of electron emission light sources 11a as shown in FIG. 2. Here, a plurality of the electron emission units may be used as a plurality of light sources, and each of the light sources may correspond to one block to provide light by blocks. Further, the electron emission display device may include a carbon nanotube (CNT).

In an implementation, the backlight unit 400 may offset the entire luminance to correspond to the luminance with which the pixel unit 100 emits the light during one frame period. In other words, if pixels that represent a high luminance are present in large numbers in the pixel unit 100 during one frame period, the back light unit 400 may emit light with a lower luminance than a predetermined luminance. If pixels that represent a low luminance are present in large numbers in the pixel unit 100 during one frame period, the backlight unit 400 may emit light with a higher luminance than a predetermined luminance. Accordingly, if the pixel unit 100 emits light with a high luminance, a luminance of the backlight unit 400 may be lowered to maintain a luminance to be represented to a certain level, thereby preventing glare. If the pixel unit 100 emits the light with a low luminance, a luminance of the back light unit 400 may be increased to a certain level to enhance contrast ratio, thereby improving visibility. Further, if the pixel unit 100 emits the light with a high luminance, power consumption may be reduced by lowering luminance to a certain level.

According to the electron emission display device according to the present invention and the liquid crystal display thereof, grey levels may be easily represented by preventing a driving waveform from being distorted by a resistor component and a capacitor component, and light emitted from the light source unit may be uniform regardless of the region from which light is emitted, since a signal transmitted to regions that are closest to and remotest from a driver may be substantially the same.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission display device, comprising:
a light source unit including a plurality of gate electrodes and a plurality of cathode electrodes, the light source unit configured to emit electrons in accordance with voltages of the gate electrode and the cathode electrode, and to direct the emitted electrons to an anode electrode;
a gate driver configured to transmit a driving waveform to the gate electrodes; and
a cathode driver configured to transmit a driving waveform to the cathode electrodes, wherein at least one driving waveform transmitted by the gate driver and the cathode driver is a non-impulse waveform.

2. The electron emission display device as claimed in claim 1, wherein the at least one driving waveform is a trapezoidal waveform.

3. The electron emission display device as claimed in claim 1, wherein the at least one driving waveform is a triangular waveform.

4. The electron emission display device as claimed in claim 1, wherein the at least one driving waveform is a semi-sinusoidal waveform.

5. The electron emission display device as claimed in claim 1, wherein the at least one driving waveform includes substantially equal rising and falling times.

6. The electron emission display device as claimed in claim 5, wherein the rising and falling times together account for at least half of a pulse width of the at least one driving waveform.

7. The electron emission display device as claimed in claim 6, wherein the rising and falling times together account for an entirety of the pulse width of the at least one driving waveform.

8. The electron emission display device as claimed in claim 5, wherein the rising and falling times each account for between about one quarter to about one half of a pulse width of the at least one driving waveform.

9. A liquid crystal display, comprising:
a pixel unit including a plurality of liquid crystal cells, the pixel unit being configured to display an image by transmitting or blocking light selectively in accordance with a data signal and a scan signal;
a data driver transmitting the data signal to the pixel unit;
a scan driver transmitting the scan signal to the pixel unit; and
a back light unit transmitting light to the pixel unit,
the backlight unit including:
a light source unit having a plurality of gate electrodes and a plurality of cathode electrodes, the light source unit configured to emit electrons in accordance with voltages of the gate electrode and the cathode electrode, and to direct the emitted electrons to an anode electrode,
a gate driver configured to transmit a driving waveform to the gate electrodes; and
a cathode driver configured to transmit a driving waveform to the cathode electrodes, wherein at least one driving waveform transmitted by the gate driver and the cathode driver is a non-impulse waveform.

10. The liquid crystal display as claimed in claim 9, wherein the at least one driving waveform is a trapezoidal waveform.

11. The liquid crystal display as claimed in claim 9, wherein the at least one driving waveform is a triangular waveform.

12. The liquid crystal display as claimed in claim 9, wherein the at least one driving waveform is a semi-sinusoidal waveform.

13. The liquid crystal display as claimed in claim 9, wherein the at least one driving waveform includes substantially equal rising and falling times.

14. The liquid crystal display as claimed in claim 13, wherein the rising and falling times together account for at least half of a pulse width of the at least one driving waveform.

15. The liquid crystal display as claimed in claim 14, wherein the rising and falling times together account for an entirety of the pulse width of the at least one driving waveform.

16. The liquid crystal display as claimed in claim 13, wherein the rising and falling times each account for between about one quarter to about one half of a pulse width of the at least one driving waveform.

17. A method of operating an electron emission display device including a light source unit having a plurality of gate electrodes and a plurality of cathode electrodes, the method comprising:
transmitting a gate driving waveform to the gate electrodes; and
transmitting a cathode driving waveform to the cathode electrodes, wherein:
at least one driving waveform of the gate driving waveform and the cathode driving waveform is a non-impulse waveform, and
electrons are emitted in accordance with voltages of the gate electrodes, the cathode electrodes and an anode electrode.
